(19) United States
(12) Patent Application Publication
(10) Pub. No.: US 2006/0082240 A1
(43) Pub. Date: Apr. 20, 2006

(54) Stator laminated plates of an enclosed type motor

(76) Inventors: Yi-Yin Lin, Daya Township (TW); Guei-tang Liao, Daya Township (TW)

Correspondence Address: TROXELL LAW OFFICE PLLC, SUITE 1404, 5205 LEESBURG PIKE, FALLS CHURCH, VA, 22041, US

(21) Appl. No.: 11/151,445

(22) Filed: Jun. 14, 2005

(30) Foreign Application Priority Data
Oct. 20, 2004 (TW) 093131907

(51) Int. Cl. H02K 1/00; H02K 1/28

(52) U.S. Cl. 310/216; 310/218; 310/254

(57) ABSTRACT

Stator laminated plates of an enclosed type motor are made of a preset number of laminated plates. Each laminated plate is composed of a main plate and two coupling plates. Each main plate is punched with a rotor inner hole, and two wing members extends from the two sides of the rotor hole, and spaced apart from the rotor hole in the same distance. Each wing member has its open end formed with an engage portion and each coupling plate assembled on the wing member of the main plate has the opposite ends respectively formed with a combining portion engaged with the engage portion of the wing member. The main plate and the two coupling plates are firmly combined together by mutual engagement of the engage portions and the combining portions, enabling the rotor to rotate smoothly and increasing the starting torsion and horsepower of the motor.

### BACKGROUND OF THE INVENTION

1. Field of the Invention

This invention relates to the stator laminated plates of an enclosed type motor, particularly to one easy to be assembled, having excellent combination strength and able to increase the starting torsion and horsepower of a motor.

2. Description of the Prior Art

The stator 1 of a conventional enclosed type motor is made of a preset number of laminated plates 10. Referring to FIGS. 1 and 2, the laminated plates 10 are respectively punched at the same location with a rotor hole 11 for receiving therein a rotor (not shown). Two symmetrical wing members 12 extend outward from the two sides of the rotor hole 11 respectively, having an recessed arc-shaped position-limiting surface 13 in the inner sides of their open ends, with a combining space 14 formed between the two arc-shaped position-limiting surfaces 13 for clamping and assembling a coupling iron core 15 therebetween. The coupling iron core 15 has its opposite ends respectively formed with a projecting arc-shaped surface 16 for facilitating the coupling iron core 15 to be slidably assembled between the two arc-shaped position-limiting surfaces 13. Further, the coupling iron core 15 is wound thereon with a coil 17 in advance so that, after making electric connection, the coupling iron core 15 can form a magnetic pole and actuate the rotor to rotate, when it is electrified.

However, as shown in FIG. 2, the coupling iron core 15 is forcedly fitted in the combining space 14 of the compressed plates 10; therefore, to achieve firm combination, the coupling iron core 15 must be a little longer than the width of the combining space 14. Thus, in an assembling process, the opposite projecting arc-shaped surfaces 16 of the coupling iron core 15 will produce an outward pushing force (p) acting on the corresponding arc-shaped position-limiting surfaces 13 and pushing the two wing members 12 to move outward. Since the connecting wall 18 between the two wing members 12 and the rotor hole 11 is very thin and weak in structure; therefore, when the two wing members 12 are pushed outward by the outward pushing force (p) of the opposite ends of the coupling iron core 15, the combining space 14 between the two wing members 12 will become wider and consequently the coupling iron core 15 is impossible to be firmly assembled together with the compressed plates 10. As a result, the strength of the whole combination structure is insufficient and the coupling iron core 15 can hardly be firmly combined with the laminated plates 10, likely to affect the stability and effect of action of magnetic pole. Further, the coupling iron core 15 is installed at only one side of the laminated plates 10 so its magnetic pole can only act on one side of the motor rotor, thus weakening the starting torsion and horsepower of the motor. Furthermore, the action of the magnetic pole is not distributed in equilibrium; therefore, during rotating, the rotor of the motor is likely to sway bias to one side to influence its rotating stability and make loud noises.

### SUMMARY OF THE INVENTION

The objective of this invention is to offer the stator laminated plates of an enclosed type motor, and each laminated plate is made of a main plate and two coupling plates. The main plate is punched with a rotor inner hole, and two wind members extending outward from the two sides of the rotor hole and spaced apart in the same distance. Each wing member has its open end formed with an engage portion, and the two coupling plates are respectively assembled with the wing members of the main plate, having the opposite ends respectively formed with a combining portion aligned to the engage portion of the wing member. The main plate and the two coupling plates can be firmly combined together by mutual engagement of the engage portions and the combining portions.

The stator laminated plates of this invention are able to elevate the combination stability of the two coupling plate and the main plate to enable the rotor to rotate smoothly and steadily, thus increasing the starting torsion and horsepower of the motor and avoiding making loud noises when the motor rotates.

### BRIEF DESCRIPTION OF DRAWINGS

This invention will be better understood by referring to the accompanying drawings, wherein:

FIG. 1 is a front view of a conventional motor stator in a combined condition:

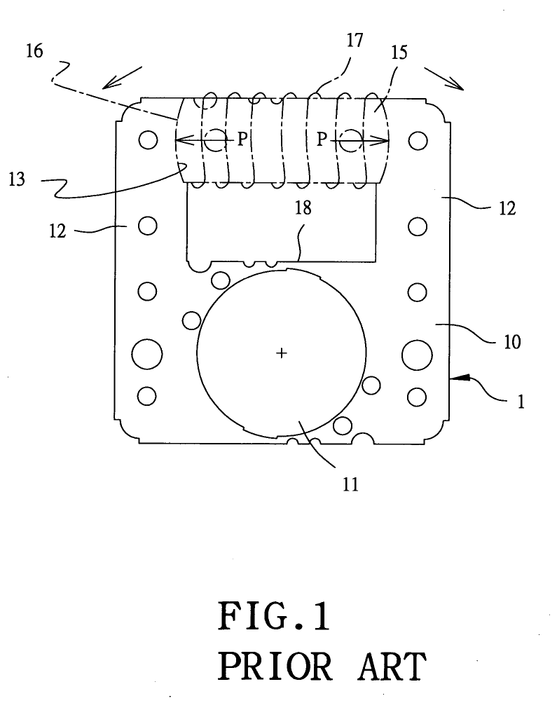

FIG. 2 is an exploded front view of the conventional motor stator:

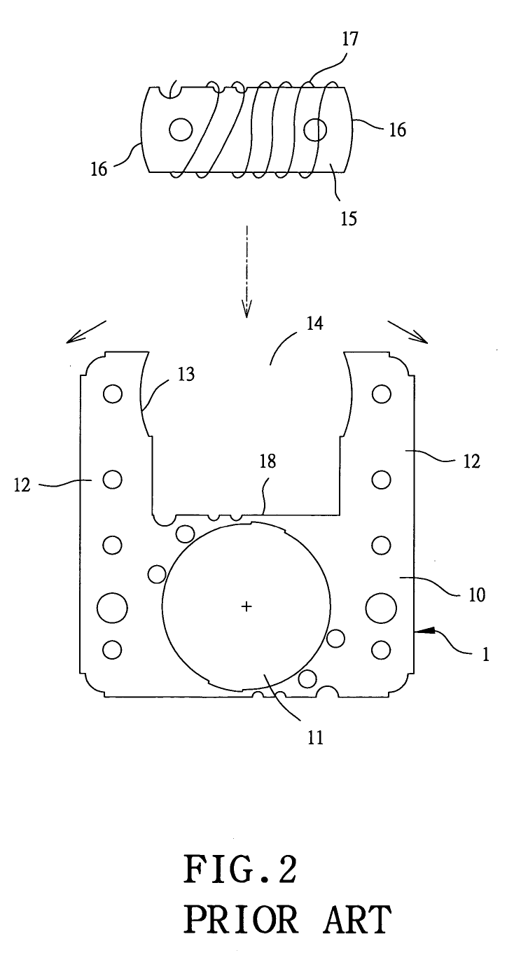

FIG. 3 is a partial exploded front view of a first preferred embodiment of a motor stator in the present invention:

FIG. 4 is a front view of the first preferred embodiment of the motor stator in a combined condition in the present invention:

FIG. 5 is a partial exploded front view of a second preferred embodiment of a motor stator in the present invention:

FIG. 6 is a partial exploded front view of a third preferred embodiment of a motor stator in the present invention: and

FIG. 7 is a partial exploded front view of a fourth preferred embodiment of a motor stator in the present invention.

### DETAILED DESCRIPTION OF THE PREFERRED EMBODIMENT

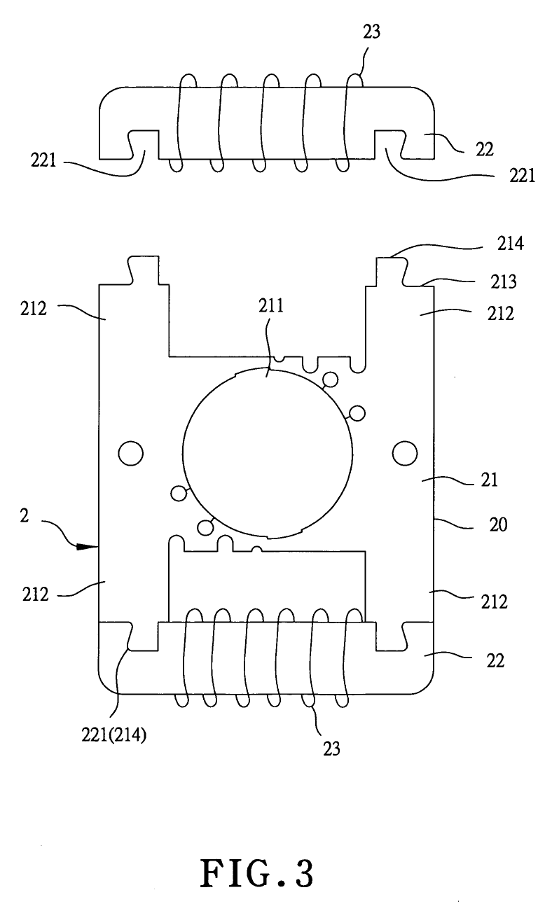

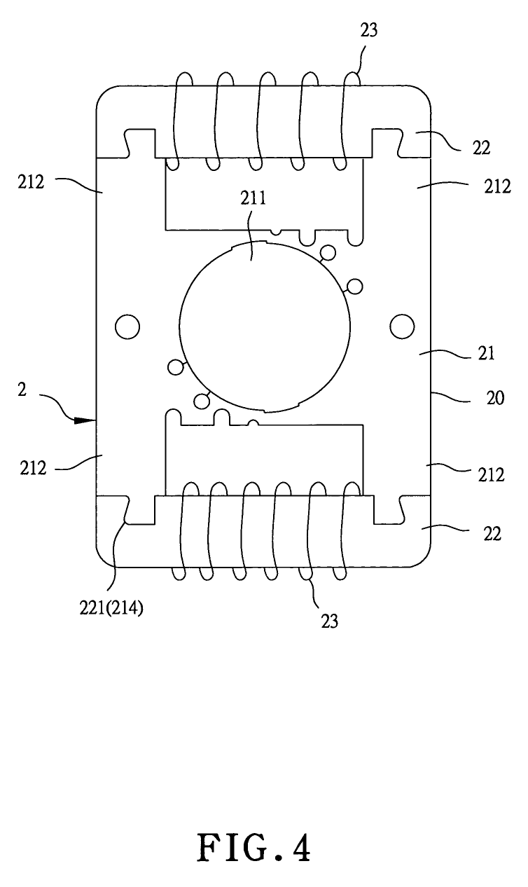

A first preferred embodiment of the stator laminated plates of an enclosed type motor in the present invention, as shown in FIGS. 3 and 4, includes a stator 2 made of a preset number of laminated plates 20. Each laminated plate 20 is made of a metallic material having magnetic conductance or non-magnetic conductance. Each laminated plate 20 is composed of a main plate 21 and two coupling plates 22.

The main plate 21 has its central portion punched with a rotor hole 211 for receiving the rotor therein. Two wind members 121 extend outward from the two sides of the rotor hole 211, separated from each other in the same distance. The wing members 212 have their open-end surfaces 213 respectively formed with an engage portion 214 for position limiting and shaped as a half dovetail block.

The two coupling plates 22 are respectively assembled on the opposite wing members 212. Each coupling plate 22 has its opposite ends respectively formed with a combining recess 221 at a location aligned to the engage projection 214 of the wing member 212 at the same side. The combining recess 221 is a half dovetail shaped position-limiting groove to be correspondingly engaged with the engage portion 214 of the wing member 212. After laminated and compression combined together, the coupling plate 22 is wound thereon with a preset coil 23 so that the coupling plate 22 is able to form magnetic pole and actuate the rotor to rotate when the coil 23 is electrified.

In assembling of the main plate 21 with the coupling plate 22, as shown in FIG. 4, the coupling plate 22 has its combining recess 221 engaged with the engage projection 214 of the main plate 21. Combined by mutual engagement of the engage projections 214 of the two wing members 212 and the combining recesses 221 of the two coupling plate 22, the two wing members 212 can completely be restricted and firmly fixed in position, impossible to be expanded outward or moved bias during assembling. Thus, the main plate 21 and the two coupling plates 22 can be firmly combined together with excellent structure strength.

Since the two coupling plates 22 and the main plate 21 are firmly combined together to make up the integrally laminated plate 20 with a stable structural strength; therefore, when the coils 23 of the two coupling plates 22 relatively act on the rotor, the magnetic pole produced by the coils is extremely stable, able to elevate the rotating stability of the rotor. Additionally, the two coupling plates 22 respectively assembled at the opposite sides of the main plate 21 enable the opposite sides of the main plate 21 to receive identical and balanced action of the magnetic pole, so the rotor is actuated to rotate smoothly and steadily and avoid slanting to one side and making loud noises. To sum up, the action of magnetic pole of the opposite sides of the stator 2 can maintain equilibrium, and the starting torsion and horsepower of the motor can also be greatly increased, thus improving the drawbacks of the conventional motor that the stator is provided with only one-side magnetic pole, unable to produce sufficient starting torsion and horsepower and that the stator cannot be combined stably, apt to make loud noises.

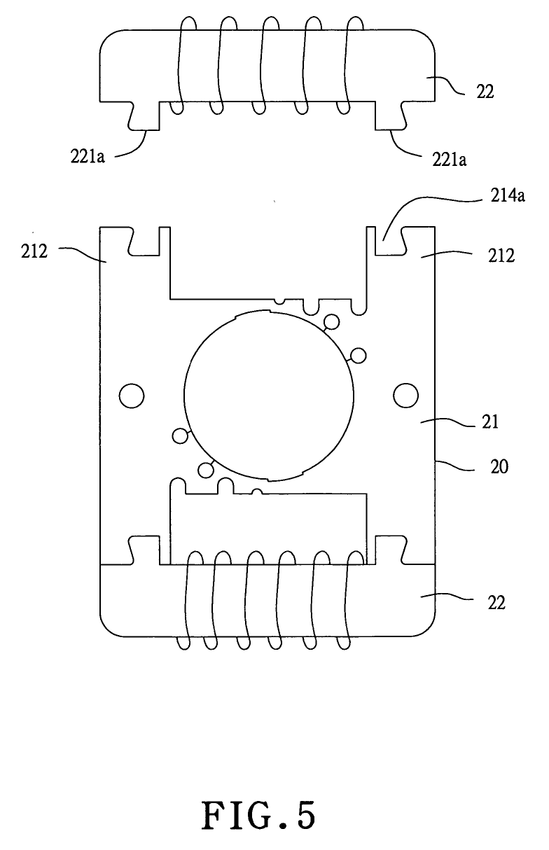

A second preferred embodiment of the stator compressed plate of an enclosed type motor in the present invention, as shown in FIG. 5, has a structure almost the same as that described in the first preferred embodiment, except that half dove-tail shaped engage recess 214a is respectively formed at the open end surface of the wing members 212 of the main plate 21 to take the place of the engage projections 214, and a half dove-tail shaped combining block 221a is respectively formed at the opposite sides of each coupling plate 22 to take the place of combining recess 221. By so designing, the main plate 21 and the two coupling plates 22 can firmly be combined together with an excellent structural strength by mutual engagement of the engage recesses 214a with the combining projections 221a.

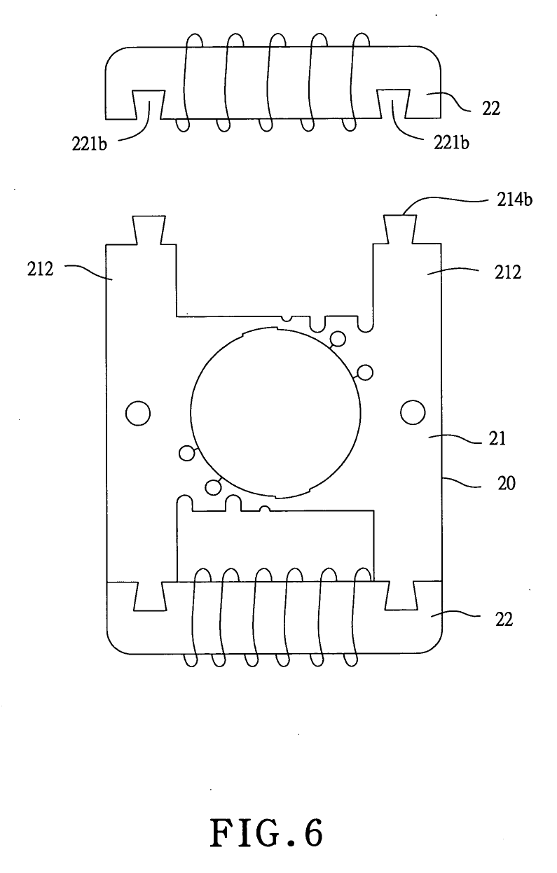

A third preferred embodiment of the stator compressed plate of an enclosed type motor in the present invention, as shown in FIG. 6, has a structure almost the same as that described in the first preferred embodiment, except that the half dove-tail shaped engage projections 214 of the wing members 212 of the main plate 21 are altered into dove-tail shaped engage projections 214b, and the half dove-tail shaped combining recesses 221 at the opposite ends of each coupling plate 22 are altered into dove-tail shaped combining recesses 221b. Thus, the main plate 21 and the two coupling plate 22 can be firmly combined together with excellent structural strength by mutual engagement of the engage projections 214b with the combining recesses 221b.

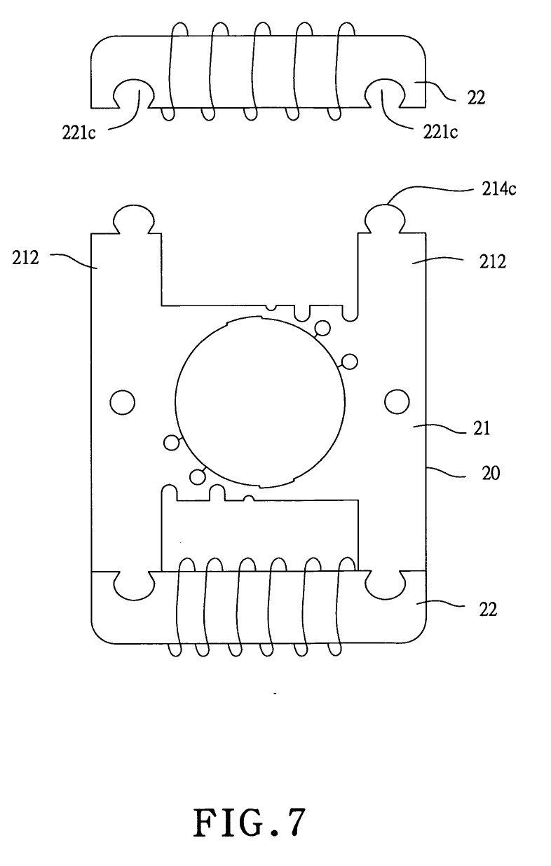

A fourth preferred embodiment of the stator compressed plate of an enclosed type motor in the present invention, as shown in FIG. 7, has a structure almost the same as that described in the first preferred embodiment, except that the engage portions 214 of the wing members 212 of the main plate 21 are altered into arc-shaped (or teardrop-shaped) engage projections 214c with an outer circumference exceeding three-fourth of a circle, and the combining recesses 221 at the opposite ends of each coupling plate 22 are altered into arc-shaped and grooved combining recesses 221c with an inner circumference exceeding three-fourth of a circle. Thus, the main plate 21 and the two coupling plates 22 can be firmly combined together with an excellent structural strength by mutual engagement of the engage projections 214c with the combining recesses 221c.

As can be understood from the above description, this invention has the following advantages.

1. The stator laminated plates are respectively made of a main plate and two coupling plates combined together, easy in assembling and having a stable structure.

2. The stator has its opposite sides respectively provided with a coupling plate wound thereon with a coil so that the opposite sides of the stator can receive equal and balanced action of a magnetic pole, able to actuate the rotor to rotate smoothly and steadily and avoid making loud noises when the motor rotates.

3. When the motor is started, the action of the two magnetic poles at the opposite sides of the stator is able to elevate the starting torsion and horsepower of the motor.

While the preferred embodiments of the invention have been described above, it will be recognized and understood that various modifications may be made therein and the appended claims are intended to cover all such modifications that may fall within the spirit and scope of the invention.

I claim:

1. Stator laminated plates of an enclosed type motor comprising a preset number of laminated plates, each said laminated plate punched at the same location with a rotor hole for receiving a rotor therein: and characterized by,
Said laminated plates respectively composed of a main plate and two coupling plates, said main plate punched with said rotor inner hole at a preset location, two wing members extending outward from two sides of said rotor hole, said two wing members separated from said rotor hole in the same distance, each said wing member having its open end surface formed with an engage portion:
Said two coupling plates respectively assembled with said wing member at the opposite sides of said main plate, each said coupling plate having the opposite ends respectively formed with a combining portion aligned to said engage portion of said wing member, said main plate and said two coupling plates able to be firmly combined together by mutual engagement of said engage portions and said combining portions, each coupling plate wound thereon with a coil after said coupling plates are laminated and compressed together, said coupling plate body forming magnetic pole to actuate said rotor to rotate after said coil is electrified.

2. The stator laminated plates of an enclosed type motor as claimed in claim 1, wherein said engage portion at the open end surface of said wing member is a position-limiting guiding rail and said combining portion of each said coupling plate is a position-limiting recess.

3. The stator compressed plate of an enclosed type motor as claimed in claim 1, wherein said engage portion of said wing member is a position-limiting recess and said combining portion of said coupling plate is a position-limiting projection.

4. The stator compressed plate of an enclosed type motor as claimed in claim 2 or 3, wherein said position-limiting recess is half dove-tail shaped and said position-limiting projection is half dove-tail shaped.

5. The stator compressed plate of an enclosed type motor as claimed in claim 2 or 3, wherein said position-limiting recess is dove-tail shaped and said position-limiting projection is dove-tail shaped.

6. The stator compressed plate of an enclosed type motor as claimed in claim 2 or 3, wherein said position-limiting recess is arc-shaped, and said position-limiting rail is arc-shaped.

7. The stator compressed plate of an enclosed type motor as claimed in claim 1, wherein said laminated plate is made of metal integrally laminated.

8. The stator compressed plate of an enclosed type motor as claimed in claim 1, wherein said laminated plate is made of a magnetic-conductance material integrally laminated.

9. The stator compressed plate of an enclosed type motor as claimed in claim 1, wherein said laminated plate is made of a non-magnetic-conductance material integrally laminated.
